(19) United States
(12) Patent Application Publication
(10) Pub. No.: US 2019/0139161 A1
(43) Pub. Date: May 9, 2019

(54) CHARGING RESERVATION SERVER AND CHARGING RESERVATION METHOD FOR ELECTRICALLY POWERED VEHICLE

(71) Applicant: TOYOTA JIDOSHA KABUSHIKI KAISHA, Toyota-shi (JP)

(72) Inventors: Satoru SAKUMA, Nagakute-shi (JP); Shuhei YAMAMOTO, Aichi-gun (JP); Munehiro KAMIYA, Anjo-shi (JP); Hideo HASEGAWA, Nagoya-shi (JP); Shinji KURACHI, Nagoya-shi (JP); Tomoya SHIMIZU, Nagoya-shi (JP)

(73) Assignee: TOYOTA JIDOSHA KABUSHIKI KAISHA, Toyota-shi (JP)

(21) Appl. No.: 16/182,139

(22) Filed: Nov. 6, 2018

(30) Foreign Application Priority Data
Nov. 8, 2017 (JP) 2017-215514

(51) Int. Cl. G06Q 50/06; B60L 11/18; G06Q 10/02; G06Q 20/10

(52) U.S. Cl. CPC G06Q 50/06; B60L 11/1848; B60L 11/185; G06Q 20/10; G06Q 10/02

(57) ABSTRACT

A charging reservation system includes a quota manager configured to manage allocation of a charging reservation quota defined by a charging location and a charging time zone in accordance with information transmitted from each of a plurality of vehicles. When a vehicle requests allocation of a reservation quota in a state where the reservation quota is allocated to a vehicle, the quota manager inquires of a user of the vehicle as to whether the user of the vehicle can agree to transfer the reservation quota or not. Then, when the user of the vehicle agrees to transfer the reservation quota, the quota manager allocates the reservation quota to the vehicle. The vehicle pays a charging point as an allocation reception fee for receiving allocation of the reservation quota. The vehicle obtains a charging point as an allocation transfer fee by transferring the reservation quota.

This nonprovisional application is based on Japanese Patent Application No. 2017-215514 filed on Nov. 8, 2017 with the Japan Patent Office, the entire contents of which are hereby incorporated by reference.

### BACKGROUND

### Field

The present disclosure relates to a charging reservation server and a charging reservation method each for an electrically powered vehicle, and more particularly to a charging reservation technique for an electrically powered vehicle including a power storage device configured to be charged with electric power supplied from outside the electrically powered vehicle.

### Description of the Background Art

As a vehicle including a power storage device configured to be charged with electric power supplied from outside the vehicle, there are an electric vehicle (EV) and a plug-in hybrid vehicle (PHV) that have begun to widely spread. Such charging will be hereinafter also referred to as “external charging”.

The number of electrically powered vehicles configured to be externally charged is expected to further increase in the years to come. Accordingly, the number of charging stations (also referred to as a charging stand, a charging spot, and the like) may become chronically insufficient. This leads to fears that there may be an increase in number of lines of vehicles waiting for utilization of the charging station or there may be an electrically powered vehicle that stops on a road due to running out of electricity because an opportunity for charging in a charging station is lost. Thus, a technique for efficiently utilizing a charging station is demanded.

For example, Japanese Patent Laying-Open No. 2012-190407 discloses a technique for allocating a charging station preferentially to a vehicle that needs to be charged, based on information such as the state of charge (SOC) of the vehicle and the distance to a charging station.

### SUMMARY

In consideration of the necessity for efficient utilization of a charging station, the present inventors have conceived to construct the mechanism by which users give and receive their “charging reservation quotas” to and from one another. The “charging reservation quota” is defined by the charging location of the charging station and the charging time zone in the charging station. A quota manager configured to manage a charging reservation quota in a charging reservation server of the electrically powered vehicle serves to intermediate the negotiation for transfer of the charging reservation quota between the vehicles. A more specific example will be described below. Specifically, when the quota manager receives an allocation request for a charging reservation quota from a vehicle (which will be referred to as an “object vehicle”) through wireless communication, but when the requested charging reservation quota has already been allocated to another vehicle, the quota manager inquires of this another vehicle through wireless communication as to whether another vehicle can agree to transfer the charging reservation quota or not. In response to this inquiry, when the quota manager receives a reply from another vehicle that this another vehicle can agree to transfer the charging reservation quota, the quota manager allocates the charging reservation quota to the object vehicle. In this way, the charging reservation quota can be transferred from another vehicle to the object vehicle.

In order to allow well-functioning of the give-and-take mechanism for a charging reservation quota, the balance between supply and demand for charging reservation quotas needs to be achieved to some extent. However, for example, there may actually be a situation where transfer of a charging reservation quota is requested even though charging is relatively less urgent or selection of the charging time zone can be flexible. This may lead to an excessive demand for a charging reservation quota.

On the other hand, for the user of the vehicle having an already reserved charging reservation quota, this user may be inquired as to whether the user can agree to transfer the charging reservation quota or not. However, it may take time and effort for the user to change the reservation to another charging station, another charging time zone or the like. Accordingly, it is also conceivable that the user of the vehicle having an already reserved charging reservation quota may also feel resistance to agree to transfer the charging reservation quota. As a result, supply of the charging reservation quota may be excessively reduced.

In this way, when the supply and demand for charging reservation quotas are not well balanced, the give-and-take mechanism for charging reservation quotas may not successfully function. As a result, allocation of the charging reservation quota may not be able to be smoothly changed.

The present disclosure has been made to solve the above-described problems. An object of the present disclosure is to provide a technique by which allocation of a charging reservation quota can be smoothly changed in accordance with a charging reservation server and a charging reservation method each for an electrically powered vehicle configured to be externally charged.

(1) A charging reservation server for an electrically powered vehicle according to an aspect of the present disclosure is configured to make a charging reservation for a plurality of vehicles each including a power storage device configured to be charged with electric power supplied from outside each of the plurality of vehicles. The charging reservation server for an electrically powered vehicle includes a quota manager configured to manage allocation of a charging reservation quota defined by a charging location and a charging time zone in accordance with information transmitted from each of the plurality of vehicles. The plurality of electrically powered vehicles include a first vehicle and a second vehicle. When the first vehicle requests allocation of a reservation quota in a state where the reservation quota is allocated to the second vehicle, the quota manager is configured to allocate the reservation quota to the first vehicle on conditions that a user of the second vehicle agrees to transfer the reservation quota and a user of the first vehicle pays an allocation reception fee for receiving allocation of the reservation quota. The user of the second vehicle obtains an allocation transfer fee by transferring the reservation quota.

(2) The quota manager is configured to present the allocation reception fee to the user of the first vehicle when the first vehicle requests allocation of the reservation quota, and inquire of the user of the second vehicle, when the user of the first vehicle agrees to pay the allocation reception fee, as to whether the user of the second vehicle can agree to transfer the reservation quota or not.

(3) The quota manager is configured to present the allocation transfer fee to the user of the second vehicle when the quota manager inquires of the user of the second vehicle as to whether the user of the second vehicle can agree to transfer the reservation quota or not, and allocate the reservation quota to the first vehicle when the user of the second vehicle agrees to the allocation transfer fee.

(4) The quota manager is configured to present the allocation transfer fee to the user of the second vehicle when the first vehicle requests allocation of the reservation quota, and inquire of the user of the first vehicle, when the user of the second vehicle agrees to transfer the reservation quota with the allocation transfer fee, as to whether the user of the first vehicle can pay the allocation transfer fee or not.

According to the configurations described in the above (1) to (4), when the user of the first vehicle who requests allocation of the charging reservation quota agrees to pay the fee for receiving allocation of the charging reservation quota (when the user consumes a charging point (described later)), the server allocates the reservation quota. Thereby, the charging reservation quota can be allocated to the user of the vehicle that actually requires the charging reservation quota. Also, the second vehicle that serves to transfer its charging reservation quota can receive the allocation transfer fee. Thus, if the second vehicle can afford to reserve another charging reservation quota, for example, because the SOC of the power storage device still remains to some extent, the second vehicle may be motivated to agree to transfer the charging reservation quota. Accordingly, as compared with the case where it is inquired as to whether the user can agree or not to transfer the charging reservation quota with no fee, the user of the second vehicle is more likely to agree to transfer the charging reservation quota. Therefore, allocation of the charging reservation quota can be smoothly changed.

(5) The allocation reception fee is set to be higher as urgency for charging of the power storage device mounted in the first vehicle is higher.

According to the configuration described in the above (5), the allocation reception fee is set to be higher as urgency for charging of the power storage device in the first vehicle is higher. For example, the allocation reception fee is set to be higher as the SOC of the power storage device is lower at the time when charging of the first vehicle is requested. Alternatively, when the first vehicle is a vehicle not including an engine as a driving force source (EV), the allocation reception fee is set to be higher than when the first vehicle is a vehicle including an engine (PHV). By setting the allocation reception fee in this way, the operator of the charging reservation server can obtain more profits, for example, when introducing the mechanism by which the operator of the charging reservation server intermediates transfer of a charging reservation quota to thereby obtain profits (obtain a part of the allocation reception fee).

(6) The plurality of vehicles further include a third vehicle. The quota manager is configured to, when the first vehicle and the third vehicle request allocation of the reservation quota, allocate the reservation quota to one of the first vehicle and the third vehicle that pays a higher allocation reception fee.

According to the configuration described in the above (6), when the first vehicle and the third vehicle request allocation of the same reservation quota, the reservation quota is allocated to one of the first vehicle and the third vehicle that indicates its intention to pay a higher allocation reception fee. In other words, an auction of the reservation quota is carried out. In this way, the reservation quota can be allocated to the vehicle that more strongly desires to receive allocation of the reservation quota (for example, the vehicle with higher urgency of external charging for user's convenience).

(7) A charging reservation method for an electrically powered vehicle according to another aspect of the present disclosure is executed for making a charging reservation for a plurality of vehicles each including a power storage device configured to be charged with electric power supplied from outside each of the plurality of vehicles. The plurality of vehicles include a first vehicle and a second vehicle. A charging reservation quota is defined by a charging location and a charging time zone. The charging reservation method for an electrically powered vehicle includes: the first step of, when the first vehicle requests allocation of a reservation quota in a state where the reservation quota is allocated to the second vehicle, causing a server to allocate the reservation quota to the first vehicle on conditions that a user of the second vehicle agrees to transfer the reservation quota and a user of the first vehicle pays an allocation reception fee for receiving allocation of the reservation quota; and the second step of providing the user of the second vehicle with an allocation transfer fee by transferring the reservation quota.

According to the method described in the above (7), allocation of the charging reservation quota can be changed smoothly as in the configuration described in the above (1).

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing the entire configuration of a charging reservation system according to the present embodiment.

FIG. 2 is a diagram schematically showing the configuration of a vehicle.

FIG. 3 is a diagram showing an example of traveling conditions of the vehicle.

FIG. 4 is a diagram for illustrating an example of a reservation list showing a charging reservation state.

FIG. 5 is a diagram for illustrating the required amount of a charging point.

FIG. 6 is a sequence diagram of an intermediating process in the first embodiment.

FIG. 7 is a sequence diagram of the intermediating process in a modification of the first embodiment.

FIG. 8 is a sequence diagram of the intermediating process in the second embodiment.

### DESCRIPTION OF THE PREFERRED EMBODIMENTS

Embodiments of the present disclosure will be hereinafter described in detail with reference to the accompanying drawings, in which the same or corresponding components are designated by the same reference characters, and the description thereof will not be repeated.

### First Embodiment

<Entire Configuration of Charging Reservation System>

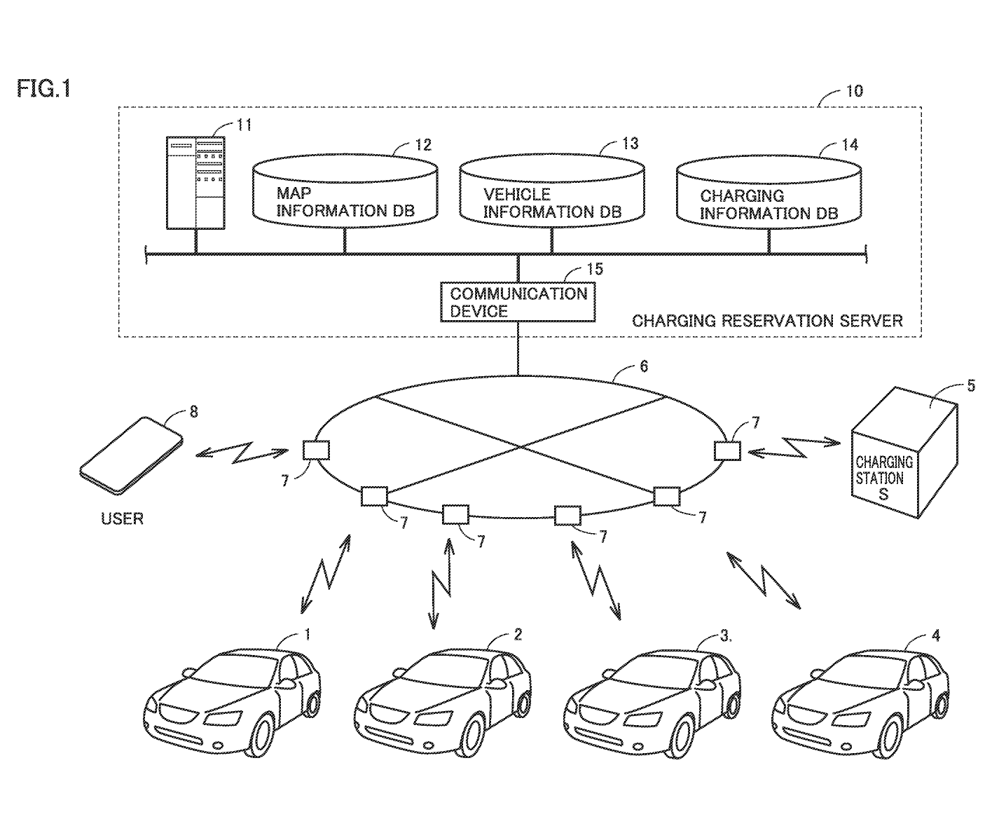

FIG. 1 is a diagram schematically showing the entire configuration of a charging reservation system according to the present embodiment. Referring to FIG. 1, in this charging reservation system, a charging reservation server 10 manages the charging reservation quota of a charging station 5 for a plurality of vehicles including vehicles 1 to 4. Although FIG. 1 shows only one charging station 5, the charging reservation quotas of further more charging stations (for example, charging stations A to C, which will be described later) are managed.

Each of vehicles 1 to 4 is an electric vehicle (EV), for example. However, each of vehicles 1 to 4 only has to be chargeable from outside (externally chargeable), and may be a plug-in hybrid vehicle (PHV). FIG. 1 shows only four vehicles 1 to 4 for preventing complicated illustration, but the number of vehicles is not particularly limited. Charging reservation server 10 manages allocation of the charging reservation quotas to further more vehicles in an actual case.

Charging reservation server 10 is configured to communicate with each of the plurality of vehicles including vehicles 1 to 4 through a base station 7 provided over a communication network 6. Also, charging reservation server 10 is configured to communicate with each of a plurality of charging stations including charging station 5 through communication network 6 and base station 7. Charging reservation server 10 may be configured to communicate with a mobile terminal 8 (for example, a smartphone) of a user.

Charging reservation server 10 includes a quota manager 11, a map information database 12, a vehicle information database 13, a charging information database 14, and a communication device 15.

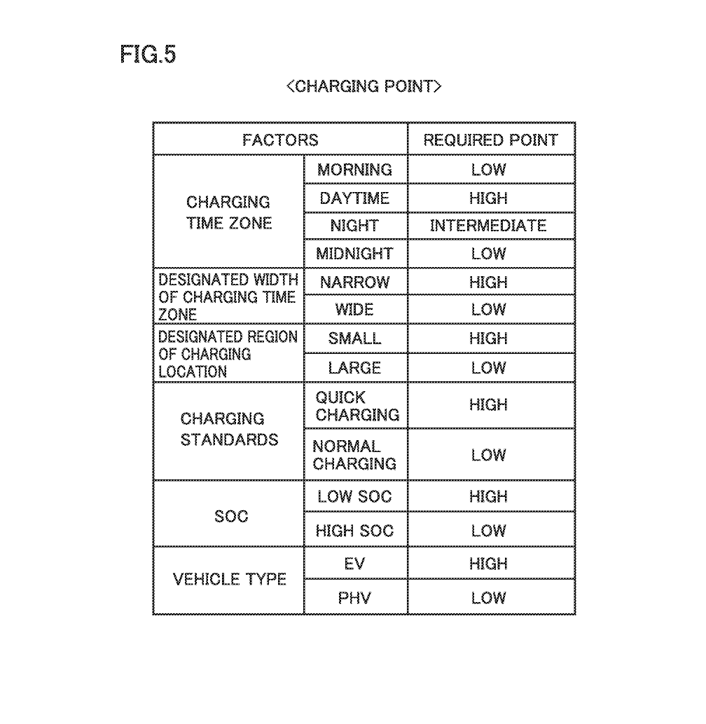

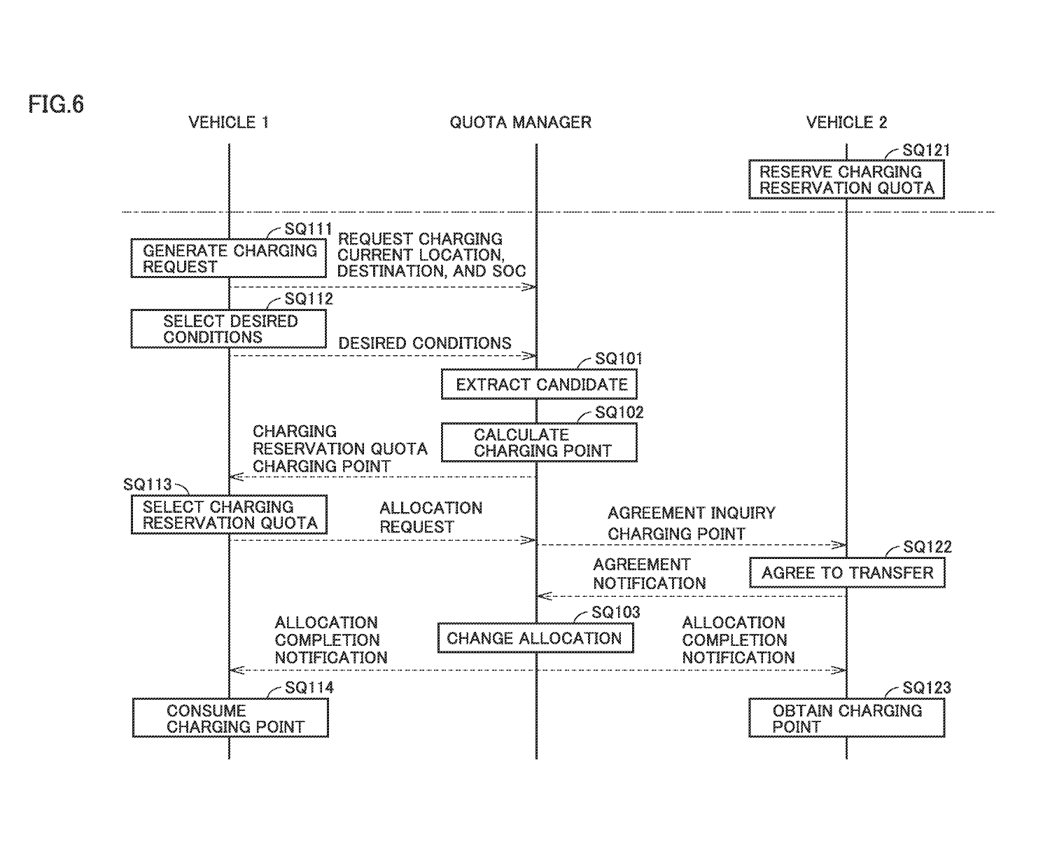

Map information database 12 stores road map information and also stores location information about the charging station. Vehicle information database 13 stores the information showing the status of use of each vehicle, the location information about each vehicle, and the like. Charging information database 14 stores the information about the charging reservation quota defined by the identification number of the charging station and the charging time zone in the charging station. The details of the information stored in charging information database 14 will be specifically described later with reference to FIGS. 5 and 6. Communication device 15 allows bidirectional communication between quota manager 11 and communication network 6.

Quota manager 11 is configured to include a central processing unit (CPU), a memory (a read only memory (ROM), a random access memory (RAM) and the like), an input/output port through which various signals are input/output, and the like, which are not shown. Various control by quota manager 11 is performed by software processing, that is, by the CPU reading the program stored in the memory. Control by quota manager 11 can be implemented also by a general-purpose server (not shown) executing the program stored in a storage medium. It is to be noted that control by quota manager 11 is not limited to software processing, but may be processed by dedicated hardware (an electronic circuit).

For example, when vehicle 1 requests a charging reservation quota, quota manager 11 selects an appropriate charging reservation quota that meets the conditions from among the charging reservation quotas of the plurality of charging stations, and then allocates the selected appropriate charging reservation quota to vehicle 1. The request for the charging reservation quota, the allocated charging reservation quota and the like may be conveyed through communication between quota manager 11 and vehicle 1, or may be conveyed through communication between quota manager 11 and mobile terminal 8 of the user.

<Vehicle Configuration>

Since vehicles 1 to 4 basically have a common configuration, the configuration of vehicle 1 will be representatively hereinafter described.

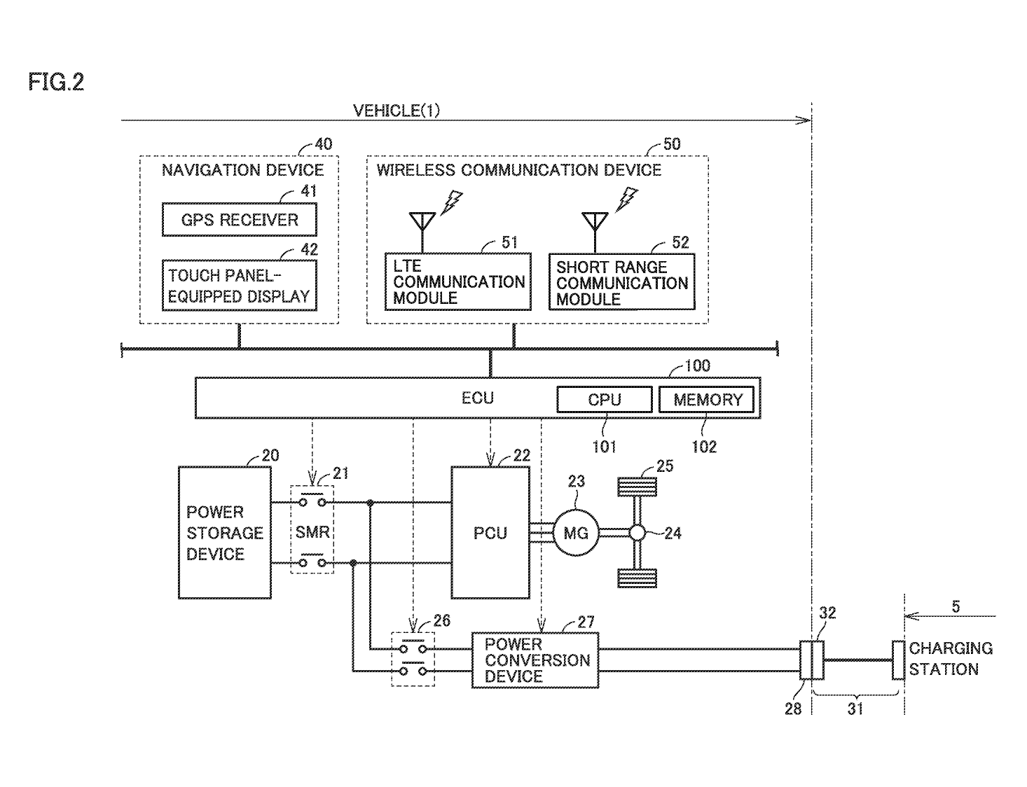

FIG. 2 is a diagram schematically showing the configuration of vehicle 1. Referring to FIG. 2, vehicle 1 includes a power storage device 20, a system main relay (SMR) 21, a power control unit (PCU) 22, a motor generator (MG) 23, a power transmission gear 24, a driving wheel 25, and an electronic control unit (ECU) 100.

Power storage device 20 is a rechargeable direct-current (DC) power supply, and configured to include a secondary battery such as a lithium-ion secondary battery or a nickel-metal hydride battery. As power storage device 20, capacitors such as an electric double layer capacitor can also be employed. Power storage device 20 supplies, to PCU 22, electric power for generating driving force for traveling of vehicle 1. Furthermore, power storage device 20 is charged with electric power generated by regenerative braking of motor generator 23 or charged with electric power supplied from outside the vehicle.

SMR 21 is electrically connected between power storage device 20 and PCU 22. SMR 21 is controlled to be closed/opened according to the command from ECU 100.

PCU 22 performs power conversion between power storage device 20 and motor generator 23 according to the command from ECU 100. PCU 22 is configured to include an inverter (not shown) configured to receive electric power from power storage device 20 to drive motor generator 23, a converter (not shown) configured to adjust the level of the DC voltage supplied to the inverter, and the like.

Motor generator 23 is an alternating-current (AC) electric motor, which is, for example, a permanent-magnet type synchronous electric motor having a rotor incorporating a permanent magnet. Motor generator 23 is driven by the inverter included in PCU 22 to rotate the drive shaft (not shown). The torque output from motor generator 23 is transmitted to driving wheel 25 through power transmission gear 24, thereby driving vehicle 1 to travel. Furthermore, during braking of the vehicle, motor generator 23 receives the rotating force of each driving wheel to generate electric power. The electric power generated by motor generator 23 is stored in power storage device 20 through PCU 22.

Vehicle 1 further includes a charging relay 26, a power conversion device 27 and an inlet 28 each as a configuration for external charging. During external charging of power storage device 20, a charging connector 32 of charging cable 31 is coupled to inlet 28. Then, the electric power supplied from a charger or the like provided in charging station 5 is supplied to vehicle 1 through charging cable 31.

Charging relay 26 is electrically connected between power storage device 20 and power conversion device 27. Charging relay 26 is closed and SMR 21 is closed to thereby allow power transfer between inlet 28 and power storage device 20.

Power conversion device 27 is electrically connected between charging relay 26 and inlet 28. According to the command from ECU 100, power conversion device 27 converts the electric power supplied from the charger or the like into electric power with which power storage device 20 can be charged. In addition, power conversion device 27 can also convert the electric power from power storage device 20 into electric power that can be output to the outside of the vehicle.

Vehicle 1 further includes a navigation device 40 and a wireless communication device 50 as the configuration for grasping the traveling conditions of vehicle 1 and for communicating with the outside of the vehicle.

Navigation device 40 includes a GPS receiver 41 configured to specify the current location of vehicle 1 based on radio waves from artificial satellites. Navigation device 40 performs various types of navigation processes for vehicle 1 using the location information about the current location of vehicle 1 specified by GPS receiver 41 (GPS information). More specifically, based on the GPS information about vehicle 1 and the road map data stored in the memory (not shown), navigation device 40 calculates a traveling route (expected traveling route or target route) from the current location of vehicle 1 to its destination, and outputs the information about the traveling route to ECU 100.

Navigation device 40 further includes a touch panel-equipped display 42. Touch panel-equipped display 42 is configured to display the current location of vehicle 1 overlaid on the road map, and to display the information transmitted from quota manager 11 to vehicle 1 or the information from ECU 100. Furthermore, touch panel-equipped display 42 receives various operations performed by the user. In addition, navigation device 40 may be configured to output audio and to be operated through voice.

Wireless communication device 50 includes a long term evolution (LTE) communication module 51 and a short range communication module 52. LTE communication module 51 is configured to allow bidirectional data communication with base station 7 in communication network 6. Short range communication module 52 is configured to allow bidirectional data communication with mobile terminal 8 of the user who is located at a short distance (for example, about several meters to several tens of meters) from vehicle 1.

ECU 100 is configured to include a central processing unit (CPU) 101, a memory 102, an input/output port (not shown) through which various signals are input/output, and the like. ECU 100 controls each of devices (SMR 21, PCU 22, charging relay 26, power conversion device 27, and the like) in vehicle 1 such that vehicle 1 is brought into a desired state. Furthermore, ECU 100 transmits and receives various pieces of information (location information about vehicle 1 and the like) to and from quota manager 11 through wireless communication device 50 (LTE communication module 51). In addition, mobile terminal 8 also can communicate with quota manager 11 through wireless communication device 50 (LTE communication module 51 and short range communication module 52).

<Intermediation of Transfer of Charging Reservation Quota>

The number of electrically powered vehicles each configured to be externally charged like vehicle 1 is expected to increase in the years to come. Accordingly, the number of charging stations may become chronically insufficient. This leads to fears that there may be an increase in number of lines of vehicles waiting for utilization of the charging station or there may be an electrically powered vehicle that stops on a road due to running out of electricity (electricity is exhausted in power storage device 20) because an opportunity for charging in a charging station is lost. Thus, a technique for efficiently utilizing a charging station is demanded.

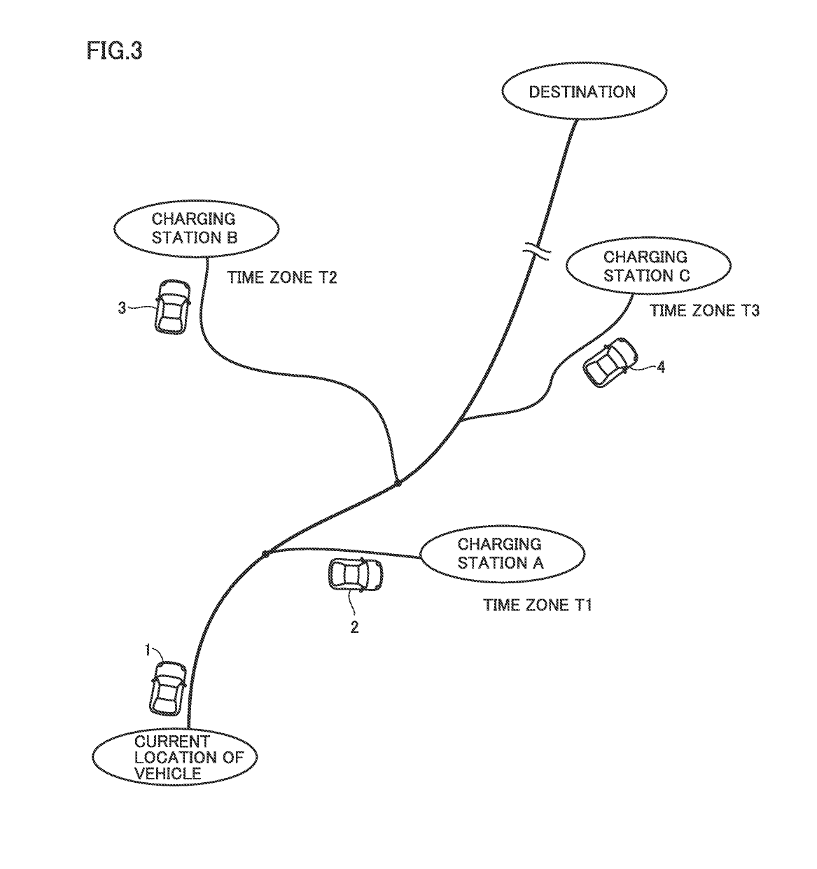

FIG. 3 is a diagram showing an example of the traveling conditions of vehicle 1. In the present embodiment, as shown in FIG. 3, an explanation will be given with regard to the situation where the SOC of power storage device 20 in vehicle 1 lowers during traveling of vehicle 1, so that vehicle 1 requests a “charging reservation quota”. The charging reservation quota means a reservation for external charging, which is defined by the location of the charging station (charging location) and the charging time zone.

As shown in FIG. 3, it is assumed that three charging stations A to C exist on an expected traveling route (or in the vicinity of the expected traveling route) from the current location of vehicle 1 to the destination thereof. Charging stations A to C are located in increasing order of distance from the current location of vehicle 1.

When vehicle 1 travels toward charging station A, the arrival time of vehicle 1 at charging station A is in a time zone T1. However, it is assumed that the charging reservation quota for charging station A in time zone T1 has already been allocated to vehicle 2.

When vehicle 1 travels toward charging station B, the arrival time of vehicle 1 at charging station B is in a time zone T2. However, it is assumed that the charging reservation quota for charging station B in time zone T2 has already been allocated to vehicle 3.

When vehicle 1 travels toward charging station C, the arrival time of vehicle 1 at charging station C is in a time zone T3. However, it is assumed that the charging reservation quota for charging station C in time zone T3 has already been allocated to vehicle 4.

Under such a situation, the present inventors have conceived to construct the mechanism by which the charging reservation quota is given and received between vehicle 1 and one of vehicles 2 to 4. In charging reservation server 10, quota manager 11 wirelessly communicates with each vehicle, to intermediate negotiations for transfer of a charging reservation quota between vehicle 1 and one of vehicles 2 to 4. In the following, this process will be referred to as an “intermediating process” and will be described in detail.

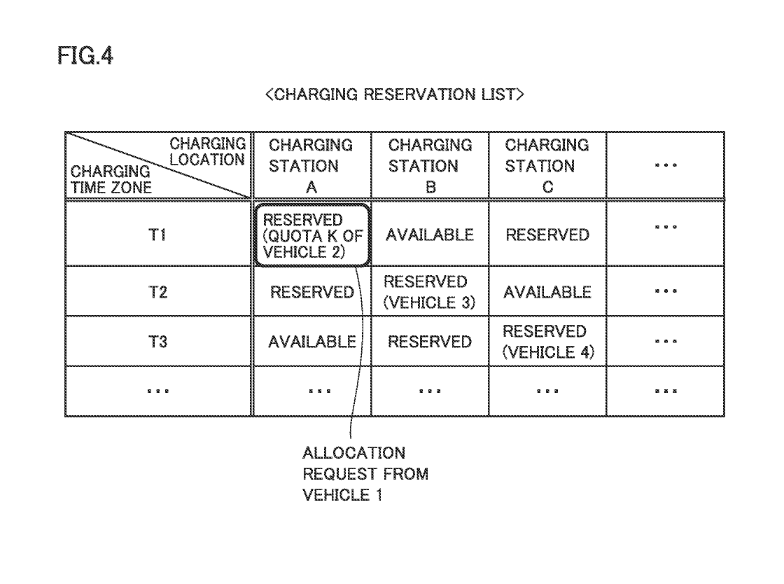

FIG. 4 is a diagram for illustrating an example of a reservation list showing a charging reservation state. In the example shown in FIG. 4, the charging reservation quota is defined by three charging stations A to C and three time zones T1 to T3. Such the reservation list is stored in charging information database 14.

In FIG. 4, “reserved” indicates a charging reservation quota that has already been reserved by one of the vehicles. Also, “available” indicates a charging reservation quota that is vacant. An image as shown in FIG. 4 is displayed on touch panel-equipped display 42 of navigation device 40 mounted in vehicle 1.

The arrival time of vehicle 1 at charging station A is in time zone T1. Accordingly, in order for vehicle 1 to be externally charged in charging station A, (i) the charging reservation quota of vehicle 2 needs to be transferred to vehicle 1, (ii) the charging reservation quota of another vehicle (not shown) in time zone T2 needs to be transferred to vehicle 1, and then, vehicle 1 needs to wait until time zone T2, or (iii) vehicle 1 needs to wait until time zone T3.

The arrival time of vehicle 1 at charging station B is in time zone T2. Accordingly, in order for vehicle 1 to be externally charged in charging station B, (i) the charging reservation quota of vehicle 3 in time zone T2 needs to be transferred to vehicle 1, or (ii) the charging reservation quota of another vehicle (not shown) in time zone T3 needs to be transferred to vehicle 1, and then, vehicle 1 needs to wait until time zone T3.

The arrival time of vehicle 1 at charging station C is in time zone T3. Accordingly, in order for vehicle 1 to be externally charged in charging station C, the charging reservation quota of vehicle 4 in time zone T3 needs to be transferred to vehicle 1.

In the situation as described above, the user of vehicle 1 operates touch panel-equipped display 42 (which may be mobile terminal 8) of navigation device 40 to select the user's desired charging reservation quota. In the following example, it is assumed that the user of vehicle 1 desires the charging reservation quota for charging station A in time zone T1, which is reserved by the user of vehicle 2 (which will be referred to as a charging reservation quota K). Vehicles 1 and 2 correspond to the “first vehicle” and the “second vehicle”, respectively, according to the present disclosure.

Vehicle 1 sends a request for charging reservation quota K to quota manager 11 through wireless communication. When quota manager 11 receives a signal from vehicle 1 indicating that charging reservation quota K is requested, quota manager 11 determines whether charging reservation quota K has already been reserved or not. In the example shown in FIG. 4, since charging reservation quota K has already been reserved by vehicle 2, quota manager 11 inquires of vehicle 2 through wireless communication as to whether vehicle 2 can agree to transfer charging reservation quota K or not. When quota manager 11 receives a reply from vehicle 2 through wireless communication stating that vehicle 2 can agree to transfer charging reservation quota K, quota manager 11 performs the process to change allocation of charging reservation quota K from vehicle 2 to vehicle 1.

In order to allow well-functioning of the give-and-take mechanism for charging reservation quotas as described above, the supply and demand for charging reservation quotas need to be balanced to some extent. When the supply and demand for charging reservation quotas are not well balanced, the give-and-take mechanism for charging reservation quotas may not successfully function. Consequently, allocation of the charging reservation quota may not be able to be smoothly changed.

Thus, the first embodiment employs the configuration in which a charging point is used as compensation for transfer and reception of a charging reservation quota. In the example shown in FIG. 4, vehicle 1 (or the user of vehicle 1) requesting allocation of a charging reservation quota pays a charging point. On the other hand, vehicle 2 (or the user of vehicle 2) that transfers its charging reservation quota receives a charging point.

By introducing the above-described mechanism, an excessive request from the user who desires to receive allocation of a charging reservation quota (for example, the request with low necessity) is suppressed. Furthermore, the user who has a charging reservation quota is also motivated to agree to transfer the user's charging reservation quota when this user receives an inquiry from quota manager 11 as to whether the user can agree to transfer the user's charging reservation quota or not. In other words, if the user transfers the charging reservation quota and receives a charging point at this time, the user will be able to desire to receive a charging reservation quota from another user by consuming the received charging point when the user subsequently requires external charging for some reason.

<Charging Point>

The charging point may be equally set, but the charging point is desirable to be set at a value in accordance with the situation of the vehicle that requires to receive allocation of a charging reservation quota, as will be described below.

FIG. 5 is a diagram for illustrating the required amount of the charging point. FIG. 5 shows charging points that are paid by the user of vehicle 1 who desires to receive allocation of a charging reservation quota (an “allocation reception fee” according to the present disclosure).

Referring to FIG. 5, by way of example, the charging point can be set in each time zone in accordance with the requested amount (demanded amount) of the charging reservation quota that the user desires to receive. For example, it is considered that, in the daytime zone, external charging of the vehicle is often required at the location where the user is away from home, so that the user often requests allocation of a charging reservation quota. On the other hand, for example, in the midnight time zone, external charging of the vehicle is often performed at the user's home and the like, so that the user relatively less often requests allocation of a charging reservation quota. Accordingly, the charging point in the daytime zone is set to be higher than the charging point in the midnight time zone.

As another example, the charging point can be set at different values in accordance with the time zone width (the number of candidates) in which the user desires to receive allocation of a charging reservation quota. By way of example, in the case where the user designates the time zone of the user's desired charging reservation quota with pinpoint accuracy (for example, in the case where the user designates time zone T1 that is the closest), the charging point is set to be higher than the case where the user designates the wider time zone width (for example, in the case where the user designate that either time zone T1 or time zone T2 may be acceptable).

Furthermore, the charging point can be set at different values also in accordance with the number of candidates for the charging station for which the user desires to receive allocation of a charging reservation quota. By way of example, in the case where the user designates the location in the vicinity of the current location, for example, as the charging location for which the user desires to receive allocation of a charging reservation quota (for example, in the case where the user designates only the inside area of the range including charging station A), the charging point is set to be higher than the case where the user designates the wider charging location (in the case where the user designates that the range of charging station B that is located away from the current location may also be acceptable).

The charger provided in the charging station has a plurality of charging standards. When a charger with relatively high charging capability (the amount of electricity that can be supplied per unit time) (that is, a charger accommodating quick charging) is used, the charging time can be reduced and the greater amount of electricity can be supplied in a certain time period, as compared with the case where a charger with relatively low charging capability (that is, a charger accommodating normal charging) is used. Accordingly, in the case where the charging station accommodating quick charging is designated, the charging point is set to be higher than the case where the charging station accommodating normal charging is designated.

Furthermore, the charging point may be set in accordance with the SOC of power storage device 20. As the SOC of power storage device 20 is lower, the necessity for external charging becomes higher, so that the charging point is set to be higher. By setting the charging point in this way, the user is motivated to perform external charging in an early stage at the time when the SOC of power storage device 20 does not excessively lowers (for example, at the time when the SOC is not close to 0%). As a result, the number of vehicles that stop on a road due to running out of electricity can be reduced.

A plug-in hybrid vehicle (PHV) includes an engine as a driving force source in addition to a motor generator. Thus, the plug-in hybrid vehicle is assumed to be lower in urgency of external charging than an electric vehicle (EV) including only a motor generator as a driving force source. Accordingly, the charging point is set to be higher for an electric vehicle than for a plug-in hybrid vehicle.

In this way, in consideration of various factors shown in FIG. 5, the charging point paid from vehicle 1 is set to be higher as the urgency of external charging is higher. For example, by preparing a list of combinations (a matrix that is not shown) of the above-mentioned factors that are weighted, the charging point can be calculated according to this matrix.

FIG. 5 shows each charging point paid by (the user of) vehicle 1 that desires to receive allocation of a charging reservation quota. The charging point received by (the user of) vehicle 2 that agrees to transfer a charging reservation quota may be the same as the charging point paid by vehicle 1. Furthermore, separately from the matrix of the charging point paid by vehicle 1, the matrix (not shown) used for calculating the charging point that is to be received by vehicle 2 may be prepared. According to this prepared matrix, vehicle 2 may receive the charging point that is different from the charging point paid by vehicle 1. Alternatively, the charging point to be received by vehicle 2 may be uniformly set independently of the conditions for vehicle 1.

<Intermediating Process Sequence>

The intermediating process is implemented by exchanging various pieces of information (signals) among vehicle 1, vehicle 2 and charging reservation server 10. Thus, the details of the intermediating process will be hereinafter described with reference to a sequence diagram.

FIG. 6 is a sequence diagram of an intermediating process in the first embodiment. FIG. 6 illustrates the sequence process (indicated by SQ) performed by vehicle 1 (more specifically, ECU 100 of vehicle 1), quota manager 11 and vehicle 2 (more specifically, ECU 100 of vehicle 2) sequentially from left to right in the figure.

In SQ121, vehicle 2 reserves a charging reservation quota according to the user's operation performed through navigation device 40 or mobile terminal 8. For example, as shown in FIG. 4, the charging reservation quota for charging station A in time zone T1 is reserved.

In SQ111, vehicle 1 generates a charging request according to the user's operation performed through navigation device 40 or mobile terminal 8. This charging request is a notification to quota manager 11 for notifying that vehicle 1 needs to be externally charged. In addition to the charging request, vehicle 1 transmits, to quota manager 11, the location information about the current location of vehicle 1, the location information about the destination of vehicle 1, and the SOC information about power storage device 20. The above-mentioned information may be transmitted to quota manager 11 periodically (for example, in each prescribed cycle) by the sequence process (not shown) different from the present sequence process.

In SQ112, vehicle 1 transmits the user's desired conditions for a charging reservation quota to quota manager 11. For example, in the example shown in FIG. 5, the conditions about the designated width of the charging time zone, the area of the designated region of the charging location, the type of the charging standards, and the like (conditions shown in FIG. 5) are transmitted from vehicle 1 to quota manager 11. These desired conditions may be defined in accordance with the user's operation each time a charging request is generated, or may be registered by the operation performed by the user in advance.

In addition, the charging request in SQ111 may be generated automatically (that is, without the user's operation), which may be triggered when the SOC of power storage device 20 falls below a prescribed reference value. In this case, in SQ112, the desired conditions registered by the operation performed by the user in advance are transmitted to quota manager 11.

In SQ101, based on the desired conditions transmitted from vehicle 1 in SQ112, quota manager 11 extracts at least one of candidates for charging reservation quotas that is to be presented to vehicle 1. For example, candidates for charging reservation quotas as showed in FIG. 4 are extracted.

In SQ102, quota manager 11 calculates a charging point required for selecting each of the candidates having already been reserved by other vehicles (the charging point consumed when a charging reservation quota is allocated to each of the candidates) from among the candidates for the charging reservation quotas extracted in SQ101. For calculating the charging point, it is desirable that various factors as described with reference to FIG. 5 are taken into consideration, though the detailed explanation thereof will not be repeated. The information about the candidate for the charging reservation quota extracted in the process of SQ101 and the information about the required charging point calculated in the process of SQ102 are transmitted to vehicle 1.

When vehicle 1 receives information from quota manager 11, vehicle 1 selects one of the charging reservation quotas according to the operation performed by the user through navigation device 40 or mobile terminal 8 (SQ113). In this case, it is assumed that the charging reservation quota reserved by vehicle 2 in the process of SQ121 is selected. The allocation request for this charging reservation quota from vehicle 1 is transmitted to quota manager 11. Quota manager 11 inquires of vehicle 2 as to whether vehicle 2 can agree to transfer its charging reservation quota or not, while presenting the information about the charging point that is to be given to vehicle 2 when vehicle 2 agrees to transfer its charging reservation quota.

The user of vehicle 2 determines whether the user of vehicle 2 can agree or not to transfer the charging reservation quota that is requested to be allocated. When the user of vehicle 2 agrees to transfer the charging reservation quota by an operation performed through navigation device 40 or mobile terminal 8, an agreement notification is transmitted from vehicle 2 to quota manager 11 (SQ122).

Although not shown, when vehicle 2 does not agree to transfer its charging reservation quota, vehicle 1 is notified of this decision made by vehicle 2. Then, vehicle 1 selects another charging reservation quota (that is, selects the second choice). Subsequently, the same process is to be repeated until another vehicle agrees to transfer its charging reservation quota.

When quota manager 11 receives the agreement notification, quota manager 11 changes allocation of the charging reservation quota from vehicle 2 to vehicle 1 (SQ103). Then, quota manager 11 notifies of vehicles 1 and 2 that the allocation changing procedure has been completed. Then, quota manager 11 receives a charging point from vehicle 1 and gives a charging point to vehicle 2. In other words, vehicle 1 consumes a charging point while vehicle 2 obtains a charging point (SQ114 and SQ123).

As described above, in charging reservation server 10 according to the present embodiment, quota manager 11 intermediates a negotiation for transfer of a charging reservation quota between vehicles (between vehicle 1 and vehicle 2 in the above-described example). Quota manager 11 presents a required charging point to vehicle 1 that requests allocation of a charging reservation quota. Thereby, vehicle 1 requests allocation of a charging quota only when vehicle 1 can consume its charging point (that is, when vehicle 1 actually requires allocation of a charging reservation quota).

Furthermore, when quota manager 11 inquires of vehicle 2 as to whether vehicle 2 can agree to transfer its charging reservation quota or not, quota manager 11 presents also the charging point that can be given to vehicle 2. Thereby, vehicle 2 is motivated to agree to transfer its charging reservation quota requested from vehicle 1 when vehicle 2 can afford to reserve another charging reservation quota, for example, because the SOC of power storage device 20 in vehicle 2 still remains to some extent. As a result, according to charging reservation server 10 in the present embodiment, allocation of the charging reservation quota can be smoothly changed.

### Modification of First Embodiment

In the sequence diagram (FIG. 6) in the first embodiment, an explanation has been given with reference to an example of the configuration in which the information about the charging point calculated by quota manager 11 is first transmitted to vehicle 1 (see SQ102). Then, the user of vehicle 1 selects one of the charging reservation quotas, and the user of vehicle 2 is inquired as to whether the user of vehicle 2 can agree to transfer the selected charging reservation quota or not (see SQ113 and SQ122). However, as will be described below, each of the users of the plurality of vehicles including vehicle 2 may be first inquired as to whether there is any charging reservation quota or not that can be transferred. Then, when there is a charging reservation quota that can be transferred, this charging reservation quota may be presented to the user of vehicle 1.

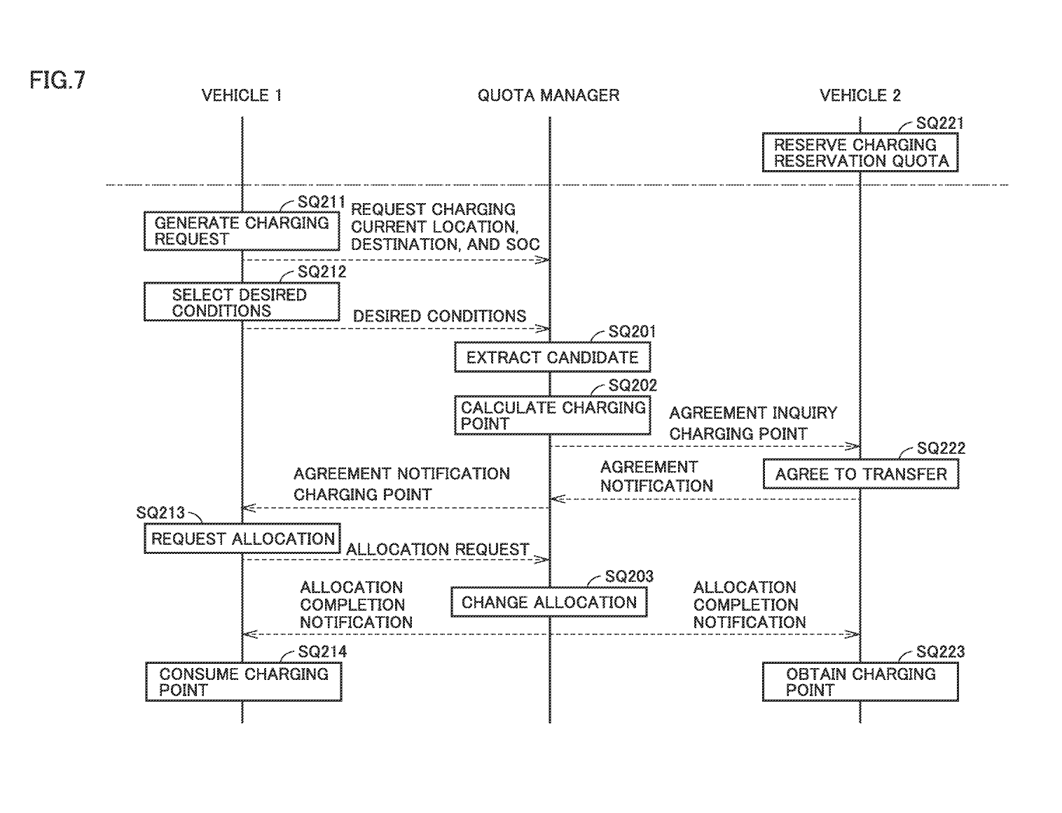

FIG. 7 is a sequence diagram of the intermediating process in a modification of the first embodiment. Referring to FIG. 7, since a series of processes up to the process of SQ202 performed by quota manager 11 is the same as the series of processes up to the process of SQ102 in the first embodiment, the description thereof will not be repeated. FIG. 7 shows only vehicle 2 due to limitations of space, but vehicle 3 is also assumed to have a charging reservation quota extracted in the process of SQ201.

Referring to FIG. 7, quota manager 11 inquires of each of the users of vehicles 2 and 3 having charging reservation quotas as to whether each of the users of vehicles 2 and 3 can agree to transfer the charging reservation quotas or not. In this case, it is preferable to transmit also the information about the charging point that can be given to each user when each user agrees to transfer the charging reservation quota.

Each of the users of vehicles 2 and 3 determines whether each of the users of vehicles 2 and 3 can agree to transfer the charging reservation quota or not. In FIG. 7, it is assumed that the user of vehicle 2 agrees to transfer the charging reservation quota by an operation performed through navigation device 40 or mobile terminal 8 (SQ222). Then, an agreement notification is transmitted from vehicle 2 to quota manager 11.

Quota manager 11 transmits, to vehicle 1, the information about the charging reservation quota agreed by vehicle 2 together with the information about the charging point required to receive allocation of the charging reservation quota. Then, it is determined whether the user of vehicle 1 desires or not to receive allocation of the charging reservation quota agreed by vehicle 2. If the user of vehicle 1 desires to receive allocation of the charging reservation quota by an operation performed through navigation device 40 or mobile terminal 8, an allocation request is transmitted from vehicle 1 to quota manager 11 (SQ213). Since the subsequent processes are the same as those in SQ103 and later in the embodiment, the detailed description thereof will not be repeated.

Also by the modification of the first embodiment as described above, transfer of a charging reservation quota is implemented with the help of the charging point as in the first embodiment. Thus, allocation of the charging reservation quota can be smoothly changed.

Furthermore, as in the first embodiment, when the charging reservation quota is first selected by vehicle 1, but when transfer of the selected charging reservation quota is not agreed by the user of another vehicle (vehicle 2 or the like), the process of selecting a charging reservation quota by the user of vehicle 1 is to be repeated. On the other hand, according to the modification of the first embodiment, the charging reservation quota for which a transfer agreement has been achieved in advance is presented to the user of vehicle 1. Thus, the repeated operation of selecting a charging reservation quota is suppressed. Accordingly, the convenience of the user of vehicle 1 can be improved.

### Second Embodiment

In the second embodiment, an explanation will be given with regard to the configuration in which, when a plurality of vehicles request allocation of the same charging reservation quota (when the same charging reservation quota is desired), the charging reservation quota is allocated to a vehicle that pays the highest charging point, and more specifically, the configuration in which an auction of a charging reservation quota is carried out.

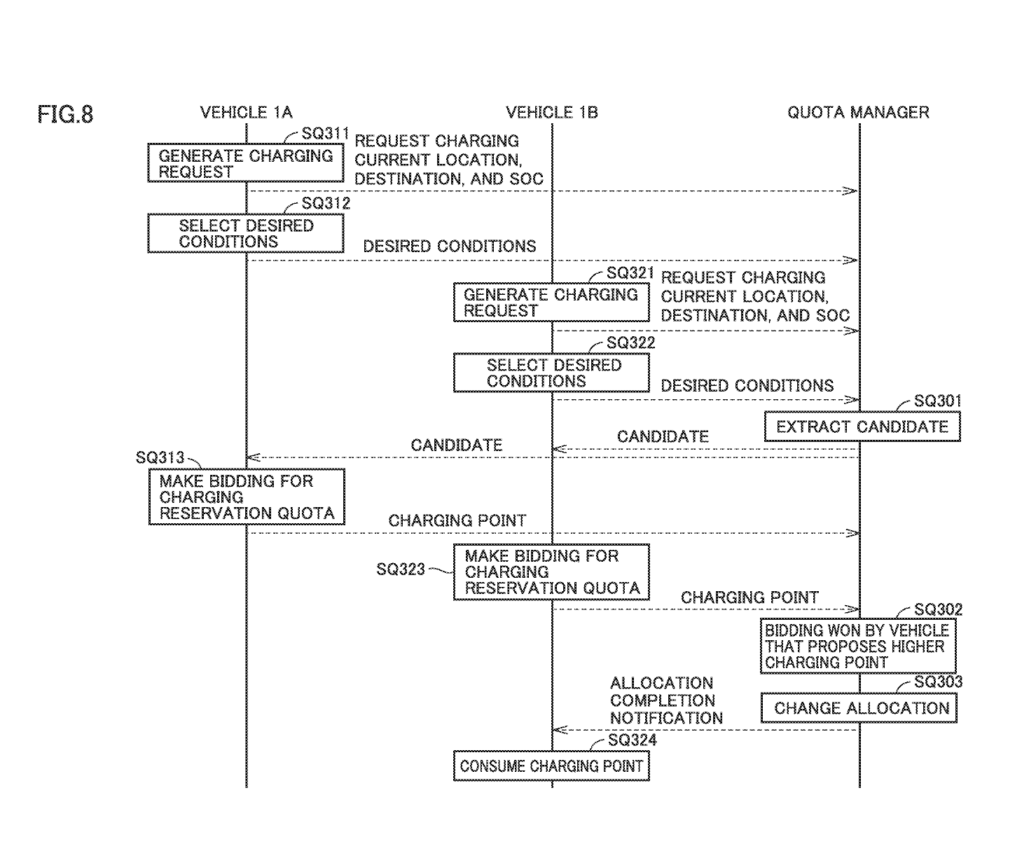

FIG. 8 is a sequence diagram of the intermediating process in the second embodiment. This sequence diagram shows the sequence process performed by vehicle 1A, vehicle 1B and quota manager 11 sequentially from left to right in the figure. Vehicles 1A and 1B each serve to request allocation of a charging reservation quota. In addition, the process performed in vehicle 2 that already has a charging reservation quota is basically the same as the corresponding process in the first embodiment, and therefore, not shown in FIG. 8 due to limitations of space. Vehicles 1A and 1B correspond to the “first vehicle” and the “third vehicle” according to the present disclosure.

Referring to FIG. 8, first, vehicle 1A generates a charging request. Then, together with this charging request (and the location information about the current location of vehicle 1A, and the like), the desired conditions for the user of vehicle 1A about the charging reservation quota are transmitted to quota manager 11 (SQ311, SQ312).

As in vehicle 1B, together with the charging request, the desired conditions for the user of vehicle 1B about the charging reservation quota are similarly transmitted to quota manager 11 (SQ321, SQ322).

In SQ301, based on various pieces of information and the desired conditions transmitted from vehicle 1A, quota manager 11 extracts a candidate for the charging reservation quota that is to be presented to the user of vehicle 1A. Furthermore, based on various pieces of information and the desired conditions that are transmitted from vehicle 1B, quota manager 11 extracts a candidate for the charging reservation quota that is to be presented to the user of vehicle 1B. In this case, it is assumed that the same candidate for the charging reservation quota (charging reservation quota K) is presented to the users of vehicles 1A and 1B.

In SQ313, in vehicle 1A, the user operates navigation device 40 or mobile terminal 8 to input a charging point that can be paid by the user for receiving allocation of charging reservation quota K presented by quota manager 11. In other words, in vehicle 1A, bidding for charging reservation quota K is made. The signal from vehicle 1A that shows a charging point (that is, a bidding price) is transmitted to quota manager 11.

Also in vehicle 1B, bidding for charging reservation quota K is similarly made (SQ323). The signal from vehicle 1B that shows a charging point (a bidding price) is also transmitted to quota manager 11.

Quota manager 11 inquires of the user of vehicle 2 as to whether the user of vehicle 2 can agree or not to transfer charging reservation quota K that is a candidate for bidding (not shown). Then, when quota manager 11 obtains a transfer agreement from the user of vehicle 2, quota manager 11 determines in SQ302 that bidding for charging reservation quota K has been won by the vehicle proposing a higher charging point (vehicle 1B in the example shown in FIG. 8). Then, quota manager 11 allocates charging reservation quota K to vehicle 1B (SQ303). The charging point of vehicle 1B is consumed accordingly.

As described above, according to the second embodiment, when vehicles 1 and 2 request allocation of the same charging reservation quota K, charging reservation quota K is allocated to vehicle 1B of the user who indicates his/her intention to pay a higher charging point. In other words, an auction of charging reservation quota K is carried out. In this way, charging reservation quota K can be allocated to a vehicle that more strongly desires to receive allocation of a charging reservation quota (for example, the vehicle with higher urgency of external charging for the user's convenience).

Furthermore, in the mechanism in which the vehicle that serves to transfer its charging reservation quota (vehicle 2 in the example described above) receives a point in accordance with the charging point paid by the vehicle that receives allocation of the charging reservation quota (vehicle 1B in the example described above) (for example, in the case where the paid charging point=the received charging point), an auction is carried out, so that the vehicle that transfers its charging reservation quota can receive a higher charging point. Accordingly, the motivation to transfer a charging reservation quota can be further enhanced.

Furthermore, it is also conceivable to introduce a mechanism in which quota manager 11 receives a part of the charging point paid from the vehicle that receives allocation of a charging reservation quota (or a mechanism in which the operator of quota manager 11 sells a charging point to a vehicle, thereby obtaining a profit). In such a case, by carrying out an auction, the operator of quota manager 11 can obtain more profits.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A charging reservation server for an electrically powered vehicle, the charging reservation server being configured to make a charging reservation for a plurality of vehicles each including a power storage device configured to be charged with electric power supplied from outside each of the plurality of vehicles, the charging reservation server comprising
a quota manager configured to:
manage allocation of a charging reservation quota defined by a charging location and a charging time zone in accordance with information transmitted from each of the plurality of vehicles, the plurality of vehicles including a first vehicle and a second vehicle; and
when the first vehicle requests allocation of a reservation quota in a state where the reservation quota is allocated to the second vehicle, allocate the reservation quota to the first vehicle on conditions that
a user of the second vehicle agrees to transfer the reservation quota, and
a user of the first vehicle pays an allocation reception fee for receiving allocation of the reservation quota, wherein
the user of the second vehicle obtains an allocation transfer fee by transferring the reservation quota.

2. The charging reservation server for an electrically powered vehicle according to claim 1, wherein
the quota manager is configured to
present the allocation reception fee to the user of the first vehicle when the first vehicle requests allocation of the reservation quota, and
inquire of the user of the second vehicle, when the user of the first vehicle agrees to pay the allocation reception fee, as to whether the user of the second vehicle can agree to transfer the reservation quota or not.

3. The charging reservation server for an electrically powered vehicle according to claim 2, wherein
the quota manager is configured to
present the allocation transfer fee to the user of the second vehicle when the quota manager inquires of the user of the second vehicle as to whether the user of the second vehicle can agree to transfer the reservation quota or not, and
allocate the reservation quota to the first vehicle when the user of the second vehicle agrees to the allocation transfer fee.

4. The charging reservation server for an electrically powered vehicle according to claim 1, wherein
the quota manager is configured to
present the allocation transfer fee to the user of the second vehicle when the first vehicle requests allocation of the reservation quota, and
inquire of the user of the first vehicle, when the user of the second vehicle agrees to transfer the reservation quota with the allocation transfer fee, as to whether the user of the first vehicle can pay the allocation transfer fee or not.

5. The charging reservation server for an electrically powered vehicle according to claim 1, wherein the allocation reception fee is set to be higher as urgency for charging of the power storage device mounted in the first vehicle is higher.

6. The charging reservation server for an electrically powered vehicle according to claim 1, wherein
the plurality of vehicles further include a third vehicle, and
the quota manager is configured to, when the first vehicle and the third vehicle request allocation of the reservation quota, allocate the reservation quota to one of the first vehicle and the third vehicle that pays a higher allocation reception fee.

7. A charging reservation method for an electrically powered vehicle, the charging reservation method being executed for making a charging reservation for a plurality of vehicles each including a power storage device configured to be charged with electric power supplied from outside each of the plurality of vehicles,
the plurality of vehicles including a first vehicle and a second vehicle,
a charging reservation quota being defined by a charging location and a charging time zone, the charging reservation method comprising:
when the first vehicle requests allocation of a reservation quota in a state where the reservation quota is allocated to the second vehicle, causing a server to allocate the reservation quota to the first vehicle on conditions that
a user of the second vehicle agrees to transfer the reservation quota, and
a user of the first vehicle pays an allocation reception fee for receiving allocation of the reservation quota; and
providing the user of the second vehicle with an allocation transfer fee by transferring the reservation quota.
